(19) United States
(12) Patent Application Publication
(10) Pub. No.: US 2008/0095330 A1
(43) Pub. Date: Apr. 24, 2008

(54) ENHANCING INTERACTIVE VOICE RESPONSE SYSTEMS VIA MESSAGING

(75) Inventors: Ling Jin, Beijing (CN); Yu Fei Ma, Beijing (CN); Pei Sun, Beijing (CN); Jun Shen, Beijing (CN); Chun Sheng Chu, Xi'an (CN)

Correspondence Address: FLEIT, KAIN, GIBBONS, GUTMAN, BONGINI & BIANCO P.L, 551 NW 77TH STREET, SUITE 111, BOCA RATON, FL, 33487, US

(73) Assignee: INTERNATIONAL BUSINESS MACHINES CORPORATION, Armonk, NY (US)

(21) Appl. No.: 11/877,952

(22) Filed: Oct. 24, 2007

(30) Foreign Application Priority Data
Oct. 24, 2006 (CN) 200610137157.4

(51) Int. Cl. H04M 11/00

(52) U.S. Cl. 379/88.13; 379/88.18

(57) ABSTRACT

Disclosed are a method, information processing system, and computer storage program product for providing communication between a user electronic device and an Interactive Voice Response (“IVR”) system. At least one selection from a user corresponding to at least one menu in an IVR system is received. The selection comprises an instruction selection sequence. At least one voice message and at least one visual message associated with the voice message, each corresponding to the instruction sequence are generated in response to the receiving. The voice message and visual message are transmitted to the electronic device associated with the user. The visual message is to be displayed to the user on an electronic device associated with the user while the voice message is being played to the user.

### CROSS-REFERENCE TO RELATED APPLICATIONS

This application is based upon and claims priority from a prior Chinese Patent Application No. 200610137157.4, filed on Oct. 24, 2006, the entire disclosure of which is herein incorporated by reference in its entirety.

### FIELD OF THE INVENTION

The present invention relates to the field of communication, and more particularly, to a method and apparatus for communicating between user equipment and an Interactive Voice Response system.

### BACKGROUND OF THE INVENTION

Nowadays call centers have become more and more popular to many companies. For example, many companies are providing more services to users through call centers. The working environment of a large call center can be envisioned as a room with numerous open-space cubicles, in which service personnel with earphones sit in front of computers, providing services to unseen users. A call center needs various resources, typically including service personnel, computers, communication equipment, and the like, among which the main cost of a call center is the cost of service personnel.

An Interactive Voice Response (“IVR”) system is often used in a telephone (including mobile telephone and fixed telephone) based call center to let users make self-service transactions so as to save costs (e.g. service personnel cost) experienced by the call center. With the IVR system, services can be provided to users around the clock without employing many service personnel. In this manner, costs of a call center will be reduced significantly. On the other hand, users can make self-service transactions via the IVR system, including caller identification, call routing, information requests and other transactions.

Normally, the number of keys on a telephone is limited. For example, an ordinary mobile telephone only has 0, 1, 2, . . . , 9, * and #. These 12 keys are pressed by a user to make different choices. However, an IVR system provides additional services, thereby making it very difficult to have a one-to-one correspondence of the services provided by an IVR system to keys on a telephone. Therefore, there is a need to divide services provided by an IVR system into stages or levels so as to make keys on a telephone correspond one-to-one to items in different stages or levels of the service.

When a user calls in through user equipment (e.g. a mobile telephone), the IVR system will send a voice signal to the user equipment, and the user equipment will then play a voice segment through its voice output device to guide the user to press different keys on the user equipment. The user usually has to hear out this voice segment before making a corresponding choice, which wastes a lot of time. Sometimes, the user will be confused about the overly complicated menu (forgetting the previous options when listening to the current option). Therefore, users might be unwilling to use the self-service functionality of the IVR system and resort to the help of service personnel. In this case, the advantages of the IVR system cannot be brought into play.

For users, they prefer to press fewer keys to obtain the service that desire, or give them a clear image about the whole menu or the current stage of the menu when being serviced. It would be convenient if an IVR system allows a user to not only hear voice prompts about the menu but also see the menu or the help information of the menu visually. Current IVR systems fail to provide this type of communication between user equipment and the IVR system.

Therefore a need exists to overcome the problems with the prior art as discussed above.

### SUMMARY OF THE INVENTION

Briefly, in accordance with the present invention, disclosed are a method, information processing system, and computer program storage product for providing communication between a user electronic device and an Interactive Voice Response (“IVR”) system. The method includes receiving at least one selection from a user corresponding to at least one menu in an IVR system. The selection comprises an instruction selection sequence. At least one voice message and at least one visual message associated with the voice message, each corresponding to the instruction sequence are generated in response to the receiving. The voice message and visual message are transmitted to the electronic device associated with the user. The visual message is to be displayed to the user on an electronic device associated with the user while the voice message is being played to the user.

In another embodiment, an information processing system for providing communication between a user electronic device and an Interactive Voice Response (“IVR”) system. The information processing system includes a memory and a processor that is communicatively coupled to the memory. The information processing system also includes an IVR module that is adapted to receive at least one selection from a user corresponding to at least one menu in an IVR system. The selection comprises an instruction selection sequence. At least one voice message and at least one visual message associated with the voice message, each corresponding to the instruction sequence are generated in response to the receiving. The voice message and visual message are transmitted to the electronic device associated with the user. The visual message is to be displayed to the user on an electronic device associated with the user while the voice message is being played to the user.

In yet another embodiment, a computer program storage product for providing communication between a user electronic device and an Interactive Voice Response (“IVR”) system. The computer program storage product includes instructions for receiving at least one selection from a user corresponding to at least one menu in an IVR system. The selection comprises an instruction selection sequence. At least one voice message and at least one visual message associated with the voice message, each corresponding to the instruction sequence are generated in response to the receiving. The voice message and visual message are transmitted to the electronic device associated with the user. The visual message is to be displayed to the user on an electronic device associated with the user while the voice message is being played to the user.

According to embodiments of the present invention, the user cannot only hear voice signals (prompts) about the menu, but also visually see the menu or the help information of the menu during communication with the IVR system via the user equipment. Therefore, users do not feel confused (e.g., forgetting the previous options when listening to the current option) with respect to the overly complicated menu. The user can user the self-service functionality of the IVR system without having to resort to the help of service personnel. In this manner, advantages of the IVR system can be brought into full play.

### BRIEF DESCRIPTION OF THE DRAWINGS

Other objects and effects of the present invention will become more apparent and easy to understand from the following description, taken in conjunction with the accompanying drawings wherein:

FIG. 1 depicts a communication system 100 in which the present invention can be implemented;

FIG. 2 depicts a flow of communication between user equipment and an IVR system according to an embodiment of the present invention;

FIG. 3A to 3D each illustrates a message sent by an IVR system to user equipment;

FIG. 4 depicts a block diagram of an IVR system according to an embodiment of the present invention;

FIG. 5 depicts a block diagram of user equipment according to an embodiment of the present invention.

Like reference numerals designate the same, similar, or corresponding features or functions throughout the drawings.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

Hereinafter, the preferred embodiments of the present invention will be described in detail.

The basic idea of the present invention is to enable a user to not only hear a voice signal or voice prompts about a menu but also see the menu or the help information of the menu by eyes (visually) during communication between the user and an IVR system via user equipment. In more detail, the IVR system not only sends to the user equipment a voice signal explaining the current level of a menu but also generates a message explaining the current level of the menu, such as a Short Message Service (SMS) message, a Multimedia Messaging Service (MMS) message and the like, and sends the message to the user equipment.

Normally, an IVR system will send to user equipment a plurality of messages corresponding to different levels of a menu. Since a conventional message sending system is an asynchronous system, i.e. it cannot ensure that the sending order of messages corresponding to different levels of the menu is completely the same as the receiving order thereof. In other words, messages such as SMS messages, MMS messages, and the like do not synchronize with the corresponding voice signals, i.e., the voice signal received at user equipment at a particular moment might be asynchronous with the message received simultaneously. Therefore, an embodiment of the present invention also proposes a scheme for solving this problem concerning synchronization.

In more detail, in this embodiment, in the IVR system aspect, a flag is added to a message (e.g. the message header) when the IVR system generates the message. For example, the flag may comprise a key sequence in which the user operates the keys on the user equipment. On the user equipment aspect, the user equipment records/updates the key sequence in which the user operates the keys on the user equipment, and upon receipt of the message, compares the recorded/updated key sequence in which the user operates the keys on the user equipment with the flag included in the received message. The received message will be displayed if the flag included in the received message corresponds to the recorded/updated key sequence in which the user operates the keys on the user equipment.

In this manner, if the message received at the user equipment corresponds to the voice signal being played, then the message will be displayed on a display screen of the user equipment. The user can see the message and perform a related operation while listening to the voice signal. If, for various reasons, the message corresponding to the voice signal being played is blocked in the message center and is not sent on time, then the message might be received by the user equipment when the voice signal corresponding to the message of next level menu is being played. In this case, the user equipment will not display this message when playing the voice signal corresponding to the message of a next level menu.

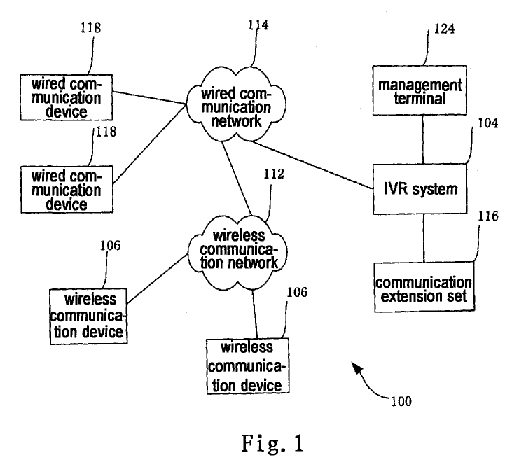

FIG. 1 depicts a communication system 100 in which the present invention can be implemented. An IVR system 104 in a call center is connected to a wired communication network 114 that can provide communication links (including audio and/or data communication links) between the IVR system 104 and a wired communication device (e.g. a fixed telephone) 118. In one example, the wired communication network 114 is a Public Switched Telephone Network (PSTN).

Moreover, the IVR system 104 may be connected to a wireless communication network 112 to implement communication between IVR system 104 and a wireless communication device 106 such as a mobile telephone or a Personal Digital Assistant (PDA) for example. In an arrangement, as depicted in FIG. 1, the IVR system 104 is connected to the wireless communication network 112 via the wired communication network 114. Of course, the IVR system 104 may be directly connected to wireless communication system 112.

The IVR functionality of communication system 100 can be configured using a management terminal 124. Further, the IVR system 104 may be connected to a communication extension set 116. For example, if the user desires service personnel to answer the problem he/she wishes to solve and has pressed the corresponding key, the IVR system 104 may switch the user to a communication extension set 116.

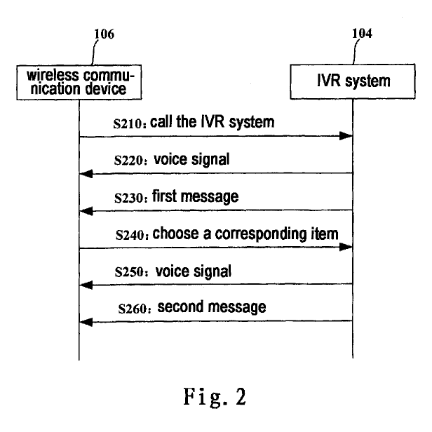

FIG. 2 depicts a flow of communication between user equipment and an IVR system according to an embodiment of the present invention.

In this embodiment, the user equipment is the wireless communication device 106, for example, such as a mobile telephone. Of course, those skilled in the art should understand that the user equipment may also be a wired communication device 118, for example, a fixed telephone.

When a user desires to communicate with the IVR system 104, he/she calls the IVR system 104 by pressing corresponding keys on the wireless communication device 106. In this embodiment, it is assumed the call number of IVR system 104 is 12345, and the IVR system 104 is an IVR system of a bank call center. In this case, the key sequence the user presses on wireless communication device 106 is 12345. It should be understood that the keys the user presses on the wireless communication device 106 may further comprise an outgoing-call key.

The wireless communication device 106 records this key sequence 12345 and sends out a request for communication setup to the IVR system 104 (step S210).

Upon receipt of this request, just like a conventional IVR system, the IVR system 104 sends a first voice signal about the first stage menu to the wireless communication device 106 through a voice channel. The first voice signal, for example, comprises a segment of greetings and options the user can choose. For instance, the first voice signal comprises “press 1 for Chinese service, press 2 for English service” (step S220).

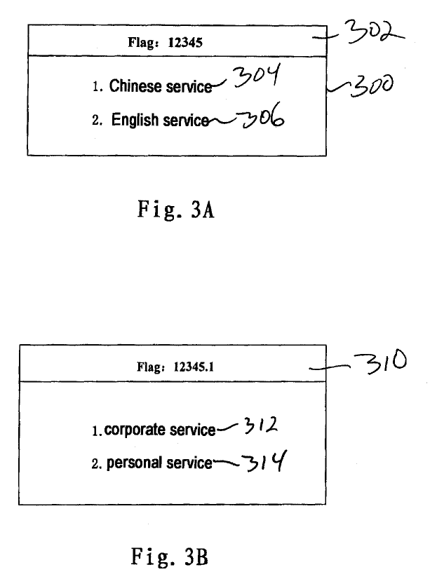

At the same time, the IVR system 104 generates a first message 300 that corresponds to the first voice signal. The (FIG. 3A) may be completely the same as the first voice signal or may explain the first voice signal. Additionally, the first message 300 (e.g. the message header) at least includes such a first flag 302 that is for identifying whether or not the first message 300 corresponds to the first voice signal. Whether or not the first message 300 is a response to an instruction corresponding to the key sequence 12345 the first message 300 can be identified via this first flag 302 (the first flag 302 is 12345 at this point).

FIG. 3A depicts an example of the first message 300. In this figure, field “Flag: 12345” 302 represents that the first flag 302 in the first message 300 is “12345,” and field “1. Chinese service” 304 and “2. English service” 306 represents that the user presses “1”, Chinese service is chosen and presses “2”, English service is chosen.

Then, the IVR system 104 sends the first message 300 to the wireless communication device 106 through a signaling channel for example (step S230) (the first message 300 may be in the form of SMS message or MMS message).

It should be understood that the first message 300 is first sent to a message center (not depicted) in the wireless communication network 112 and then forwarded to the wireless communication device 106 by the message center.

Upon receipt of the first message 300, the wireless communication device 106 compares the recorded key sequence “12345” the user presses with the aforesaid first flag 302 “12345”. In this embodiment, the first flag 302 corresponds to the recorded key sequence. Therefore, the wireless communication device 106 automatically displays the first message 300.

In this manner, the user cannot only hear the first voice signal about the menu via the user equipment but also see the menu or the help information of the menu being displayed on the display screen of the user equipment. Therefore, he/she can make a corresponding choice quickly (for example, after the user sees the first message 300, he/she can make a corresponding choice without hearing out the first voice signal).

If the first flag 302 does not correspond to the recorded key sequence, the wireless communication device 106 does not display the first message 300.

Having scanned the first message 300 and/or listened to the voice signal, the user presses key 1 on the wireless communication device 106 to choose Chinese service.

The wireless communication device 106 records the user's pressing action, updates the recorded key sequence 12345 as 12345.1, and sends the choice instruction to IVR system 104 (step S240).

Upon receipt of the choice instruction, the IVR system 104 sends a second voice signal about the second stage menu corresponding to the instruction to the wireless communication device 106 through the voice channel. The second voice signal, for example, comprises options the user can choose, such as “press 1 for corporate services, press 2 for personal services” (step S250).

At the same time, the IVR system 104 generates a second message 308 (FIG. 3B) that corresponds to the second voice signal. The second message 308 may be completely the same as the second voice signal or may explain the second voice signal. Additionally, the second message 308 (e.g. the message header) at least includes such a first flag 310 that indicates which menu the second message 308 belongs to. That is to say, whether or not the second message 308 is a response to an instruction corresponding to the key sequence 12345.1 the second message 308 can be identified via this first flag 310 (the first flag 310 is 12345.1 at this point).

FIG. 3B depicts an example of the second message 308. The meaning of each field 312, 314 in FIG. 3B is similar to that of each field in FIG. 3A, and details thereof are omitted accordingly.

Then, the IVR system 104 sends the second message 308 to the wireless communication device 106 through the signaling channel for example (step S260).

Upon receipt of the second message 308, the wireless communication device 106 compares the updated key sequence “12345.1” with the first flag 310 “12345.1” included in the received second message 308. In this embodiment, the first flag 310 included in the received second message 308 corresponds to the updated key sequence. Therefore, the wireless communication device 106 automatically displays the second message 308 on its display screen.

If the first flag 310 in the second message 308 does not correspond to the updated key sequence, the wireless communication device 106 does not display the second message 308.

For the purpose of succinctness, the description of this embodiment is finished here. Having scanned the second message 308 and/or listened to the voice signal, the user can make a corresponding choice.

In this manner, the wireless communication device 106 can play at least one voice signal received from the IVR system 104 in order and display at least one message received from the IVR system 104 in order. The at least one message corresponds to the at least one voice signal respectively.

In other words, according to an embodiment of the present invention, the wireless communication device 106 plays, in order, the at least one voice signal generated by IVR system 104 in order. In this period, the wireless communication device 106 judges whether or not the received message corresponds to the voice signal being played. If yes, then wireless communication device 106 displays the message at the same time; otherwise, it does not display the message. Therefore, for various reasons, if the wireless communication device 106 is unable to receive a message in synchronization with the corresponding voice signal thereof, it does not display the message.

In this manner, it is ensured that the displayed message corresponds to the voice signal being played. If the wireless communication device 106 does not receive a message corresponding to a voice signal during playing the voice signal, then it does not display a corresponding message in this period. Therefore, the problem concerning synchronization between voice signals and messages are solved in a desired way.

In another embodiment of the present invention, as depicted in FIGS. 3C and 3D, the aforesaid first and second messages 300, 308 sent by the IVR system 104 each further comprise a second flag 416, 418 (From) by which it is able to identify whether or not the message comes from IVR system 104. For example, the second flag 416, 418 is the number of the IVR system (12345).

At the wireless communication device 106 aspect, there are further comprised the steps of recording information corresponding to the second flag. For example, the information may be the same as the second flag 416, 418, for example, is the number of the IVR system 12345, or may be different from the second flag 416, 418 provided that wireless communication device 106 and IVR system 104 reach an agreement. Another step is comparing the information with the second flag 416, 418, and the conditions for displaying the message further comprise that the information corresponds to the second flag 416, 418.

One advantage of this embodiment is that the wireless communication device 106 can interact with a plurality of IVR systems without being confused.

Of course, those skilled in the art should understand that the first flag is not limited to the key sequence in which the user operates keys on the user equipment to input the instruction sequence. This is true as long as key sequence can reflect the one-to-one correspondence between respective messages and respective voice signals sent by IVR system 104 so that wireless communication device 106 can judge the correspondence. For example, the portion before the dot in the first flag may also be the number of wireless communication device 106 or even any flag (e.g. 0).

Optionally, the first flag 302, 310 may be set as the form of A0A1A2A3A4 . . . , in which A0 may be any character and corresponds to the message corresponding to the first voice signal; A1 is in a value range of a, b, c, . . . , each of them respectively corresponds to respective messages corresponding to the plurality of second voice signals, and so on and so forth. In this case, the wireless communication device 106 may compare information corresponding to the voice signal being played with the first flag 302, 310 of a received message. If the information corresponds to the first flag 302, 310, then the message is deemed to correspond to the voice signal. Otherwise, the message is not deemed to correspond to the voice signal.

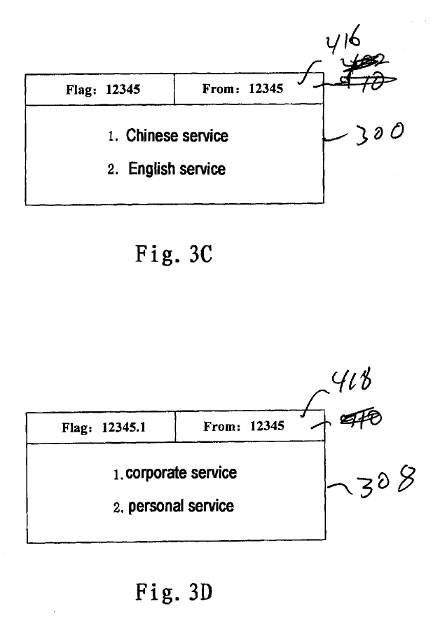

FIG. 4 depicts a block diagram of IVR system 104 according to an embodiment of the present invention. As depicted in FIG. 4, IVR system 104 comprises: receiving means 42 for receiving an instruction sequence from user equipment; generating means 44 for generating, in accordance with the instruction sequence, at least one voice signal and at least one message that can be seen by a user, the at least one message corresponding to the at least one voice signal respectively; and transmitting means 46 for transmitting the at least one message and the at least one voice signal to the user equipment in order.

In an embodiment, the at least one message each comprises a first flag 302, 310 that can be used for judging whether or not the at least one message corresponds to the at least one voice signal respectively. In another embodiment, the at least one first flag 302, 310 comprises a key sequence in which the user operates the keys on the user equipment to input the instruction sequence. In yet another embodiment, the at least one message each further comprises a second flag 416, 418 that can be used for judging whether or not the at least one message comes from the IVR system. The at least one message, in one embodiment, is transmitted to the user equipment in the form of Short Message Service message. In another embodiment, the at least one message is transmitted to the user equipment in the form of Multimedia Messaging Service message.

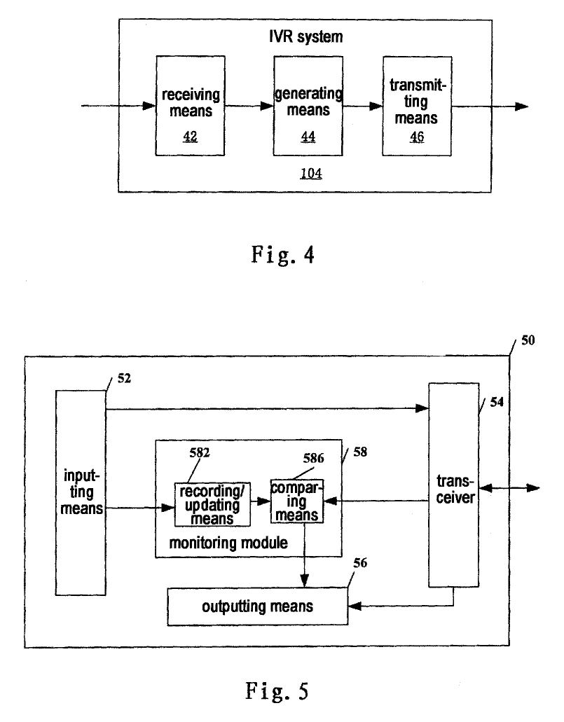

FIG. 5 depicts a block diagram of user equipment according to an embodiment of the present invention. As depicted in FIG. 5, user equipment 50 such as a wireless communication device, comprises and inputting means 52. The inputting means 52 comprises keys for inputting an instruction sequence. The user equipment also includes a transceiver 54 for transmitting to an IVR system the instruction sequence inputted via inputting means 52. The transceiver 54 is also for receiving from the IVR system at least one voice signal and at least one message that can be seen by a user. The at least one voice signal and the at least one message are generated by the IVR system in accordance with the instruction sequence, and the at least one message corresponding to the at least one voice signal respectively. The user equipment also includes an outputting means 56 for playing the at least one voice signal and for displaying the at least one message. For example, outputting means 56 may include a display screen, a loudspeaker and/or earphones etc.

According to an embodiment of the present invention, the at least one message each comprises a first flag 302, 310. The first flag 302, 310 comprises a key sequence in which the user operates keys on the user equipment to input the instruction sequence, so that it can be used for judging whether or not the at least one message corresponds to the at least one voice signal respectively. User equipment 50 further comprises a monitoring module 58 that comprises a recording/updating means 582. The recording/updating means 582 is for recording/updating a key sequence in which the user operates keys on the user equipment to input the instruction sequence. The user equipment also includes a comparing means 586 for comparing the recorded/updated key sequence with the first flag 302, 310 included in a received message. If the first flag 302, 310 included in the received message corresponds to the recorded/updated key sequence, then the comparing means 586 causes the outputting means 56 to display this message.

According to another embodiment of the present invention, the at least one message each further comprises a second flag 416, 418 that can be used for judging whether or not the at least one message comes from the IVR system. The recording/updating means 582 is further for recording information corresponding to the second flag 416, 418 and the comparing means 586 is further for comparing the information with the second flag. The conditions for displaying the message by the outputting means 56 further comprise that the information corresponds to the second flag.

It should be noted that in order to facilitate easier understanding of the present invention, the foregoing description omits more detailed technical details that are well known to those skilled in the art and might be indispensable to the implementation of the present invention.

The specification of the present invention has been presented for purposes of illustration and description, and is not intended to be exhaustive or limited to the invention in the form disclosed. Many modifications and variations will be apparent to those of ordinary skill in the art.

For example, such a modification may be made that the user may first store the number of an IVR system to a list of a wireless communication device. Only when the IVR system which a user calls is an IVR system among the list, will monitoring module 58 be triggered.

Therefore, the embodiments were chosen and described in order to best explain the principles of the invention, the practical application thereof, and to enable those of ordinary skill in the art to understand that all modifications and alterations made without departing from the spirit of the present invention fall into the protection scope of the present invention as defined in the appended claims.

The present invention can be realized in hardware, software, or a combination of hardware and software. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

In general, the routines executed to implement the embodiments of the present invention, whether implemented as part of an operating system or a specific application, component, program, module, object or sequence of instructions may be referred to herein as a “program.” The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for providing communication between a user electronic device and an Interactive Voice Response (“IVR”) system, the method on an information processing system including the IVR system, the method comprising:
receiving at least one selection from a user corresponding to at least one menu in an IVR system, wherein the selection comprises an instruction selection sequence;
generating, in response to the receiving, at least one voice message and at least one visual message associated with the voice message, each corresponding to the instruction sequence; and
transmitting the voice message and visual message to the electronic device associated with the user, wherein the visual message is to be displayed to the user on an electronic device associated with the user while the voice message is being played to the user.

2. The method of claim 1, wherein the visual message is a Short Message Service message.

3. The method of claim 1, wherein the visual message is a Multimedia Messaging Service message.

4. The method of claim 1, wherein the visual message includes at least one flag for synchronizing the visual message with the voice message.

5. The method of claim 4, further comprising:
analyzing the one flag;
determining, in response to the analyzing, that the visual message corresponds to the voice message; and
transmitting, in response to determining that the visual message corresponds to the voice message, the visual message to the electronic device.

6. The method of claim 4, wherein the one flag comprises the selection instruction sequence, wherein the selection instruction sequence indicates a sequence of keys on the electronic device selected by the user.

7. The method of claim 8, wherein the visual message includes at least one additional flag, wherein the at least one additional flag indicates a sender of the visual message.

8. An information processing system for providing communication between a user electronic device and an Interactive Voice Response (“IVR”) system, the information processing system comprising:
a memory;
a processor communicatively coupled to the memory;
an IVR module communicatively coupled to the memory and the processor, the IVR module adapted to:
receive at least one selection from a user corresponding to at least one menu in an IVR system, wherein the selection comprises an instruction selection sequence;
generate, in response to the receiving, at least one voice message and at least one visual message associated with the voice message, each corresponding to the instruction sequence; and
transmit the voice message and visual message to the electronic device associated with the user, wherein the visual message is to be displayed to the user on an electronic device associated with the user while the voice message is being played to the user.

9. The information processing system of claim 8, wherein the visual message is one of:
a Short Message Service message; and
a Multimedia Messaging Service message.

10. The information processing system of claim 8, wherein the visual message includes at least one flag for synchronizing the visual message with the voice message.

11. The information processing system of claim 10, wherein the IVR module is further adapted to:
analyze the one flag;
determine, in response to the analyzing, that the visual message corresponds to the voice message; and
transmit, in response to determining that the visual message corresponds to the voice message, the visual message to the electronic device.

12. The information processing system of claim 10, wherein the one flag comprises the selection instruction sequence, wherein the selection instruction sequence indicates a sequence of keys on the electronic device selected by the user.

13. The information processing system of claim 8, wherein the visual message includes at least one additional flag, wherein the at least one additional flag indicates a sender of the visual message.

14. A computer program storage product for providing communication between a user electronic device and an Interactive Voice Response (“IVR”) system, the computer program storage product comprising instructions for:
receiving at least one selection from a user corresponding to at least one menu in an IVR system, wherein the selection comprises an instruction selection sequence;
generating, in response to the receiving, at least one voice message and at least one visual message associated with the voice message, each corresponding to the instruction sequence; and
transmitting the voice message and visual message to the electronic device associated with the user, wherein the visual message is to be displayed to the user on an electronic device associated with the user while the voice message is being played to the user.

15. The computer program storage product of claim 14, wherein the visual message is a Short Message Service message.

16. The computer program storage product of claim 14, wherein the visual message is a Multimedia Messaging Service message.

17. The computer program storage product of claim 14, wherein the visual message includes at least one flag for synchronizing the visual message with the voice message.

18. The computer program storage product of claim 17, further comprising instructions for:
analyzing the one flag;
determining, in response to the analyzing, that the visual message corresponds to the voice message; and
transmitting, in response to determining that the visual message corresponds to the voice message, the visual message to the electronic device.

19. The computer program storage product of claim 17, wherein the one flag comprises the selection instruction sequence, wherein the selection instruction sequence indicates a sequence of keys on the electronic device selected by the user.

20. The computer program storage product of claim 14, wherein the visual message includes at least one additional flag, wherein the at least one additional flag indicates a sender of the visual message.
